(19) United States
(12) Patent Application Publication
(10) Pub. No.: US 2023/0090360 A1
(43) Pub. Date: Mar. 23, 2023

(54) ANTI-OVERFLOW COOKING PLATES

(71) Applicant: RJ BRANDS, LLC, Mahwah, NJ (US)

(72) Inventor: Aleksandr Klebanov, Mahwah, NJ (US)

(73) Assignee: RJ BRANDS, LLC, Mahwah, NJ (US)

(21) Appl. No.: 17/477,587

(22) Filed: Sep. 17, 2021

(51) Int. Cl. A47J 37/06

(52) U.S. Cl. CPC A47J 37/0611; A47J 2037/0617

(57) ABSTRACT

Provided for is a waffle maker comprising a top plate bound by a top body and a bottom plate bound by a bottom body, a cavity bound by the top plate and the bottom plate, the cavity configured to accept a batter, and a reservoir bound by a top plate reservoir trench and a bottom plate reservoir trench. The waffle maker may further comprise a sliding crescent gate bound by a top plate inner rim and a bottom plate inner rim, where the top plate inner rim is configured to rise as the batter expands.

### FIELD OF INVENTION

The invention is in the field of kitchen appliances, specifically, appliances that utilize cooking plates, waffle makers, and waffle makers configured to minimize batter overflow.

### INTRODUCTION

While millions of individuals choose to cook waffles in their homes, waffle makers available to the public are often messy and/or inefficient. Many waffle makers on the market experience batter overflow during their operational cycles. Batter overflow may be defined as when the batter drips down the sides of the appliance and onto countertops, causing a mess for the user. The overflow may initiate when the top lid rises and allows batter to flow over the waffle plates.

Currently, many industry leaders choose to allow the customer to deal with the cleanup that is required to use such an appliance. Many other manufactures attempt to combat overflow by adding overflow receptacles or dedicated external areas to hold excess batter flowing from the seam of the waffle maker.

Further, such problems exist across many other kitchen appliances, for example, many griddles and presses.

Therefore, it would be desirable to have kitchen applicants that decrease overflow. Further, it would be desirable to have a waffle maker that efficiently cooks waffles while preventing batter overflow.

### BRIEF DESCRIPTION OF THE DRAWINGS

FIG. 1 is an illustration of the cross-section of an embodiment of the waffle maker.

FIG. 2 is a perspective view of an embodiment of the waffle maker.

FIG. 3 is a perspective view of an embodiment of the plates.

FIG. 4 is a front cross-sectional view of an embodiment of the waffle maker.

FIGS. 5A-5B are section views of embodiments of the plates.

FIG. 6 is a section view of an embodiment of the plates containing batter.

### DETAILED DESCRIPTION

The present invention adds a whole new dimension to cooking plates, waffle making, and waffle making appliances.

Throughout the specification, wherever practicable, like structures will be identified by like reference numbers. In some figures, components, such as additional electrical connections or fasteners have been omitted for clarity in the drawings. Unless expressly stated otherwise, the term “or” means “either or both” such that “A or B” includes A alone, B alone, and both A and B together.

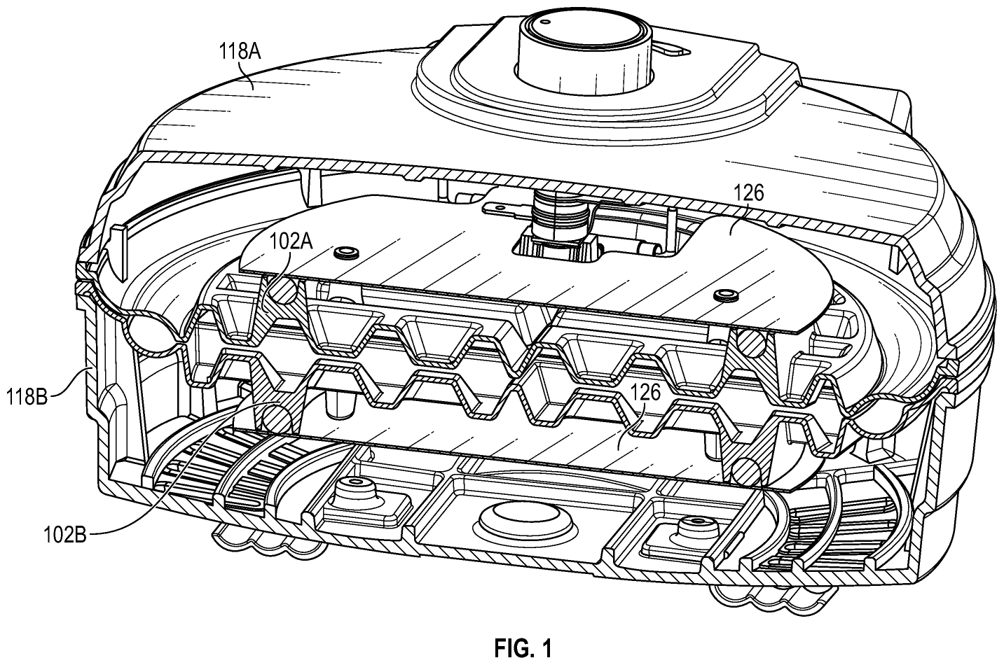

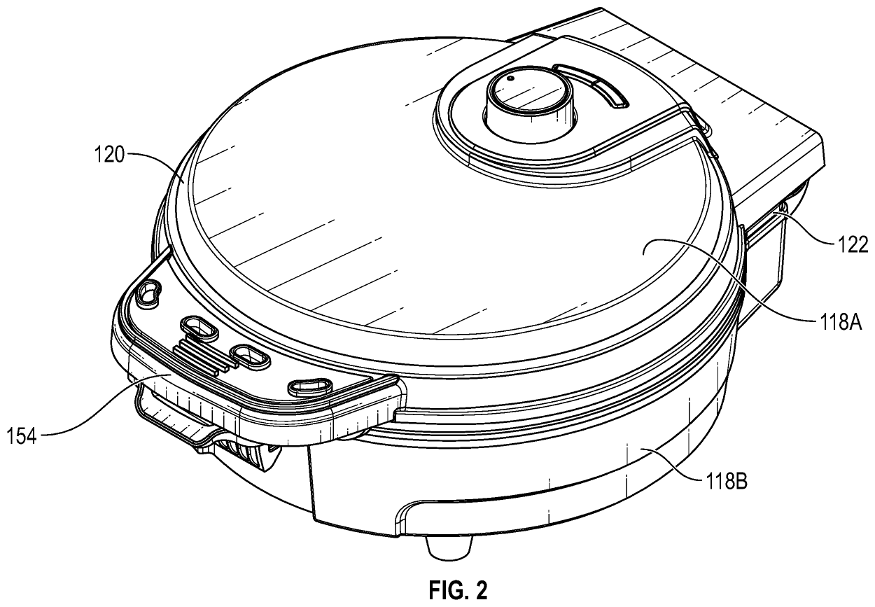

Referring to FIGS. 1-2, in an embodiment, the waffle maker includes a top plate 102A and a bottom plate 102B. The top plate 102A and the bottom plate 102B may be circular members composed of metal (for example, aluminum, steel, or iron). However, in an alternate embodiment the plates 102A/102B may be composed of any suitable material (for example, ceramic). The top plate 102A may be partially encapsulated by at least a top body 118A and the bottom plate 102B may be partially encapsulated by at least a bottom body 118B. The top body 118A and the bottom body 118B may collectively form a body 120.

One or more hinges 122 may movably attach the top body 118A and the bottom body 118B. In another embodiment, one or more hinges 122 movably attach the top plate 102A and the bottom plate 102B. In yet another embodiment, one or more hinges 122 attach the top plate 102A, the bottom plate 102B, the top body 118A, and the bottom body 118B. In an alternate embodiment, the top plate 102A and the bottom plate 102B are movably attached via another mechanism, for example, a swing, a pivot, or a “twist-and-lock” mechanism. The body 120 may include any suitable means of temporarily (for example, reversibly and/or movably) disposing the top plate 102A above the bottom plate 102B.

In an embodiment, the waffle maker is non-hinged, such that the user places the top plate 102A above the bottom plate 102B. In an embodiment, the top plate 102A has sufficient weight to apply the downward pressure necessary to facilitate efficient waffle cooking.

In an embodiment, a front hinge 154 may further join the top body 118A and the bottom body 118B. For example, a front hinge 154, such as a lock, pin, or interlocking handle, may be disposed on the front portions of the top body 118A and the bottom body 118B. In such an embodiment, the user may lift the top body 118A and top plate 102A via the front hinge 154. A top handle member may be disposed on the front portion of the top body 118A, such that a user may utilize the top handle member to open and close the device. The top handle member may extend radially from the top body 118A and may include any number or configuration of grips or handholds. For example, the top handle member may include a number of ridges or the top handle member may be textured. A bottom handle member may be disposed on the front portion of the bottom body 118B, such that the bottom handle member and the top handle member contact when the device is in the closed position. However, in alternate embodiments, the top handle member and the bottom handle member do not contact. In a further alternate embodiment, the device may include both handle members, one handle member, or neither handle member. The bottom handle member may extend radially from the bottom body 118B. In an embodiment, the top handle member and the bottom handle member are configured to interface, such that the plates 102A/102B index properly.

The apparatus may include a heating element 126. The heating element 126 may be in thermal communication with the top plate 102A and/or the bottom plate 102B. The heating element 126 may transfer heat to the top plate 102A and/or the bottom plate 102B via conduction. However, in an alternate embodiment, the heating element 126 may transfer heat via radiation, convection, or another means of heat transfer. The quantity of heat transferred to the top plate 102A and/or bottom plate 102B may be sufficient to convert liquid batter to a cooked waffle (or from batter to another baked good or food item). The heating element 126 may be disposed within the top body 118A and/or the bottom body 118B. In an embodiment, the apparatus includes two or more heating elements 126. For example, there may be two heating elements, with one heating element 126 on each plate 102A/102B.

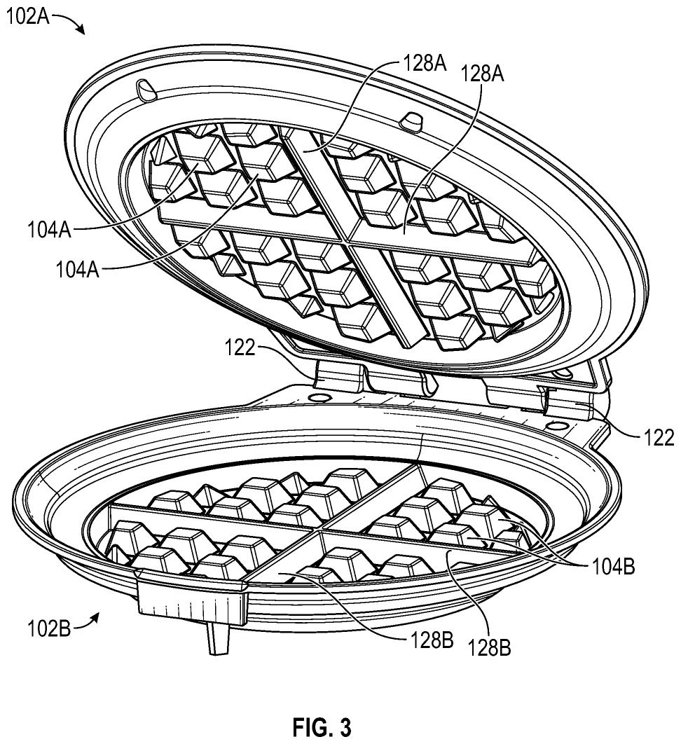

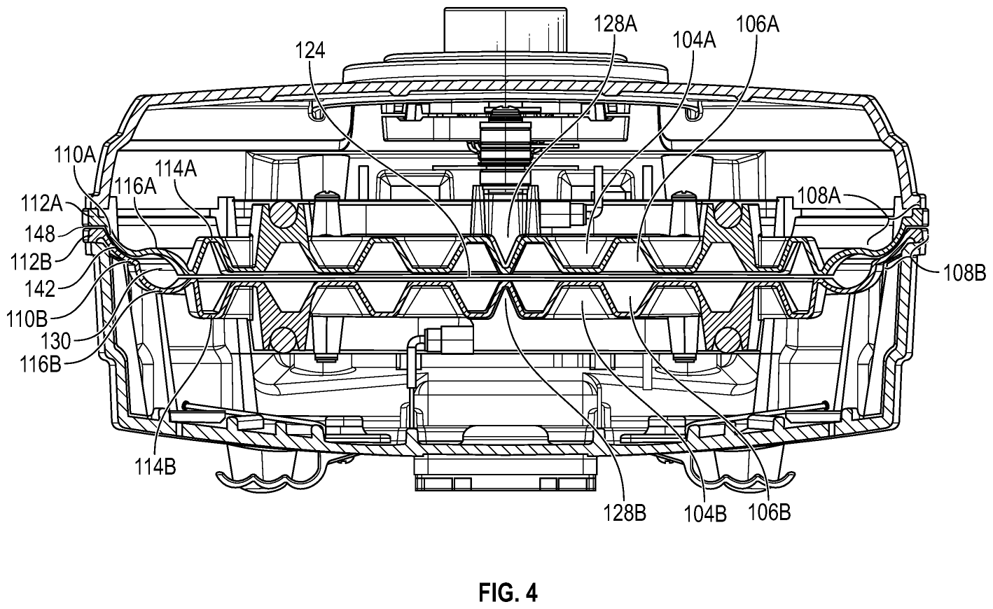

Referring to FIGS. 3-4, in an embodiment, the top plate 102A and/or the bottom plate 102B are configured to accept batter (for example, liquid waffle batter). The top plate 102A and the bottom plate 102B may each include a plurality of teeth 104A/104B and a plurality of grooves 106A/106B. The top plate 102A and the bottom plate 102B may also each include top plate partitions 128A and/or bottom plate partitions 128B, respectively. The top plate partitions 128A and/or the bottom plate partitions 128B may be configured to divide the cavity 124 and, in effect, a waffle into quadrants. However, in alternate embodiments, the top plate partitions 128A and the bottom plate partitions 128B may divide the cavity 124 and, in effect, a waffle into any number of portions. The partitions 128A/128B may be disposed amongst the plurality of the teeth 104A/104B and the plurality of grooves 106A/106B, such that the partitions 128A/128B traverse the cavity 124. The cavity 124 may be the volume existing between the top plate 102A, the bottom plate 102B, and the reservoir 130 (including the reservoir 130). In another embodiment, the cavity 124 may be the volume existing between the top plate 102A, the bottom plate 102B, and the circumferential trench 128 (including the circumferential trench 128).

In an embodiment, the top plate partitions 128A and the bottom plate partitions 128B are complimentary (for example, when the apparatus is in the closed position, the top plate partitions 128A and the bottom plate partitions 128B share the same horizontal coordinates). In an alternate embodiment, the top plate 102A and the bottom plate 102B may be configured in a non-isometric configuration. In such an alternate embodiment, the top plurality of teeth 104A may align with the bottom plurality of grooves 106B and the top plurality of grooves 106A may align with the bottom plurality of teeth 104B.

Further, the top plate 102A may include a top plate rim 108A and the bottom plate 102B may include a bottom plate rim 108B. The top plate rim 108A and the bottom plate rim 108B may be disposed circumferentially around their respective plate 102A/102B. The top plate rim 108A may include an inner top plate rim 110A and an outer top plate rim 112A. The bottom plate rim 108B may include an inner bottom plate rim 110B and an outer bottom plate rim 112B. The top plate 102A and the bottom plate 102B may include a top circumferential trench 114A and a bottom circumferential trench 114B, respectively. In an embodiment, the top circumferential trench 114A and the bottom circumferential trench 114B form a circumferential trench 128. In an embodiment, the top plate 102A and the bottom plate 102B may include a top reservoir trench 116A and a bottom reservoir trench 116B, respectively. In an embodiment, the top reservoir trench 116A and the bottom reservoir trench 116B form a reservoir 130. In an embodiment, the reservoir 130 is not designed to accept batter initially from the user. For example, the user may pour batter into the bottom plurality of grooves 106B and the bottom circumferential trench 114B. In such an embodiment, the reservoir 130 may fill with batter as the batter expands during cooking.

In an embodiment, the top reservoir trench 116A and the bottom reservoir trench 116B are curved. In an embodiment, the top reservoir trench 116A and the bottom reservoir trench 116B may have opposite concavities. For example, the top reservoir trench 116A may be a concave down curve and the bottom reservoir trench 116B may be a concave up curve. However, in an alternate embodiment, the top reservoir trench 116A and the bottom reservoir trench 116B may have any curvature. In an embodiment, the reservoir 130 is consistent around the entirety of the device. For example, the reservoir 130 may have identical cross-sections at any point along the reservoir 130. In an alternate embodiment, the reservoir 130 is non-uniform. In such an embodiment, the reservoir 130 may narrow or widen at some points.

The top plate 102A and the bottom plate 102B may be complimentary, such that the top plate 102A and the bottom plate 102B may interface. The top plate 102A and the bottom plate 102B may be configured in a number of embodiments to facilitate a complimentary interfacing of the two plates 102A/102B. In an embodiment, when interfacing, the top plate 102A and the bottom plate 102B form a cavity 124. For example, the cavity 124 may be sized to convert batter to a waffle. In an embodiment, the top plate 102A and the bottom plate 102B are partially or completely isometric (for example, having the same geometries). In an embodiment, the plurality of grooves 106A/106B, the plurality of teeth 104A/104B, the partitions 128A/128B, and the circumferential trenches 114A/114B are isometric. In such an embodiment, the reservoir trenches 116A/116B and rim 108A/108B components may not be isometric. In an embodiment, the plurality of grooves 106A/106B, the plurality of teeth 104A/104B, the partitions 128A/128B, and the circumferential trenches 114A/114B are symmetric about the waffle parting line 140. In an embodiment, the reservoir trenches 116A/116B and rim 108A/108B components may not be symmetric about the waffle parting line 140.

The top plate teeth 104A and the bottom plate teeth 104B may be sized to form a teeth distance 132 when the two plates 102A/102B are interfacing (for example, the distance between the top plate 102A and the bottom plate 102B where two complimentary teeth meet). The top plate grooves 106A and the bottom plate grooves 106B may be sized to form a groove distance 134 when the two plates 102A/102B are interfacing (for example, the distance between the top plate 102A and the bottom plate 102B where two complimentary grooves meet).

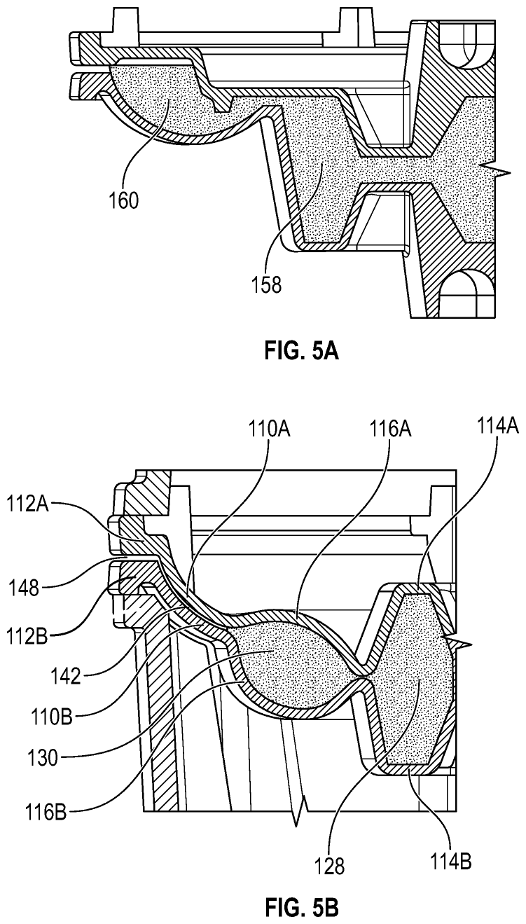

FIG. 5A illustrates an alternate embodiment of the top plate 102A and the bottom plate 102B. In such an embodiment, there is an absence of the sliding crescent gate. Instead, in such an embodiment, one or more overflow channels may be disposed on the outer most portions of the top plate 102A and the bottom plate 102B. In such an embodiment, the overflow channels capture excess batter as the batter expands and expels from the cavity. In an embodiment, the top plate 102A and the bottom plate 102B may form a first overflow channel 158 and a second overflow channel 160.

FIG. 5B illustrates an embodiment of the top plate 102A and the bottom plate 102B where the inner top rim 110A and the inner bottom rim 110B form a sliding crescent gate 142. In such an embodiment, the sliding crescent gate 142 is configured to widen as the batter expands and expels from the cavity 124.

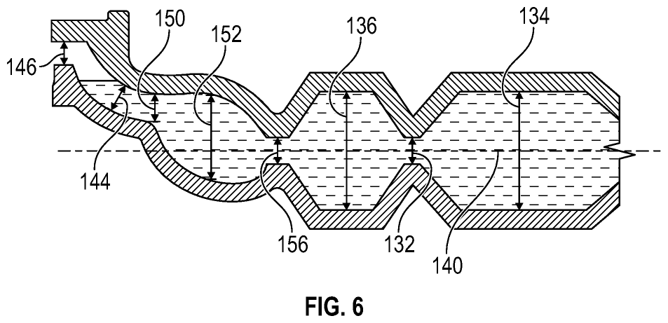

Referring to FIG. 6, the top circumferential trench 114A and the bottom circumferential trench 114B may be sized to form a circumferential trench distance 136 when the plates 102A/102B are interfacing (for example, the distance between the top plate 102A and the bottom plate 102B where two complimentary circumferential trenches meet). The top partitions 128A and the bottom partitions 128B may be sized to form a partition distance 138 (not shown) when the plates 102A/102B are interfacing (for example, the distance between the top plate 102A and the bottom plate 102B where two complimentary partitions meet). For the purposes of this disclosure, the sliding crescent gate 142 as depicted in FIG. 6 should be understood to close before initiating cooking. For example, the inner rims as depicted in FIG. 6 should be understood to make complete contact before initiating cooking.

A waffle parting line 140 may be a demarcation that intersects the cavity 124 horizontally. For example, the waffle parting line 140 may bisect the cavity 124. The waffle parting line 140 may be half the teeth distance 132 from a top plate or bottom plate tooth 104A/104B. The waffle parting line 140 may be half the groove distance 134 from a top plate or bottom plate groove 106A/106B. The waffle parting line 140 may be half the circumferential trench distance 136 from the top plate or bottom plate trench 116A/116B. The waffle parting line 140 may be half the partition distance 138 from the top plate or bottom plate partition 128A/128B.

In an alternate embodiment, the waffle parting line 140 may be a horizontal line, parallel to the plates 102A/102B, positioned vertically at the point where the top plate 102A meets (or most closely meets) the bottom plate 102B at the first opening of the reservoir 130, for example, the reservoir inlet 156.

In an embodiment, the waffle parting line 140 intersects, but does not bisect, the reservoir 130. In an embodiment, the waffle parting line 140 intersects the reservoir 130 at approximately the thirty five percent mark. However, in another embodiment, the waffle parting line 140 may be configured to intersect the reservoir 130 at any location. In an embodiment, the position of the waffle parting line 140 is a function of the horizontal seam on a cooked waffle (for example, the seam that divides the top half of the waffle from the bottom half of the waffle).

In an embodiment, the inner top plate rim 110A and the inner bottom plate rim 110B may form a sliding crescent gate 142 when the two plates 102A/102B are interfacing. In an embodiment, the plates 102A/102B may be configured such that the plates 102A/102B touch along the sliding crescent gate 142 before the batter has sufficiently expanded. The inner top plate rim 110A and the inner bottom plate rim 110B may be curved. For example, the curve may be exponential, parabolic, or generally curved. In an embodiment, the inner top plate rim 110A and the inner bottom plate rim 110B may extend vertically away from the bottom plate 102B and horizontally away from the top plate 102A. In an embodiment, the curves of each inner rim 110A/110B are complimentary, such that entire length of the inner top plate rim 110A and the entire length of the inner bottom plate rim 110B are in contact when the two plates 102A/102B are interfacing. However, in another embodiment, an inner rim distance 144 may exist between the inner top plate rim 110A and the inner bottom plate rim 110B. In various embodiments, the inner rim distance 144 may be non-zero or zero in the passive mode (for example, before batter or heat).

In an embodiment, the sliding crescent gate 142 is above the waffle parting line 140, and thus, not intersected by the waffle parting line 140. However, in an alternate embodiment, the waffle parting line 140 may intersect the sliding crescent gate 142. In an embodiment, the waffle parting line 140 is mobile, such that the waffle parting line 140 rises as the top plate 102A rises, enabling the waffle parting line 140 to remain equidistant from the top plate 102A and the bottom plate 102B. In an embodiment, the sliding crescent gate inlet 150 is higher than the reservoir inlet 156. In another embodiment, the sliding crescent gate inlet 150 is disposed at the same vertical level as the reservoir inlet 156.

In an embodiment, the cross-sectional length (for example, the length of the curvature of the plate at the inner rim) of the inner top plate rim 110A is less than the cross-sectional length of the inner bottom plate rim 110B. Alternatively, the cross-sectional length of the inner top plate rim 110A may be the same or greater than the cross-sectional length of the inner bottom plate rim 110B.

In an embodiment, the reservoir inlet 156 includes a reservoir inlet top and a reservoir inlet bottom. For example, the reservoir inlet top may be the portion of the reservoir inlet 156 formed by the top plate 102A and the reservoir inlet bottom may be the portion of the reservoir inlet 156 formed by the bottom plate 102B. In an embodiment, the sliding crescent gate inlet 150 includes a sliding crescent gate inlet top and a sliding crescent gate inlet bottom. For example, the sliding crescent gate inlet top may be the portion of the top plate 102A forming the sliding crescent gate inlet and the sliding crescent gate inlet bottom may be the portion of the bottom plate 102B forming the sliding crescent gate inlet. In an embodiment, the sliding crescent gate inlet top is disposed higher than the reservoir inlet top. The sliding crescent gate inlet bottom may be disposed higher than the reservoir inlet bottom. In an embodiment, the sliding crescent gate inlet top is more gently curved than sliding crescent inlet bottom. For example, the sliding crescent gate inlet bottom may “drop off” quickly.

In an embodiment, the preferred length and/or curvature of the sliding crescent gate 142 is a function of the volume of the reservoir 130. For example, if the reservoir 130 is a small volume, then the reservoir 130 may fill quickly, requiring a longer sliding crescent gate 142 to accommodate the excess overflow. As an alternative example, if the reservoir 130 is a large volume, then the reservoir 130 may fill slowly, allowing a shorter sliding crescent gate 142.

In an embodiment, the outer top plate rim 112A and the outer bottom plate rim 112B may be flat, straight, and/or horizontal. For example, the outer top plate rim 112A and the outer top plate rim 112B may be parallel to the waffle parting line 140. In an embodiment, a non-zero outer rim distance 146 exists between the outer top plate rim 112A and outer bottom plate rim 112B. However, the outer rim distance 146 may be zero. For example, the outer rim distance 146 may be zero in a passive mode (before heating the batter). In an embodiment, the outer rims 112A/112B form a seal 148. The seal 148 may be above the waffle parting line 140, and thus, not intersected by the waffle parting line 140. However, the seal 148 may be configured to separate as the top plate 102A rises.

In an embodiment, the top plate 102A is configured to rise as the batter rises (for example, the batter's expansion from heat exposure), while maintaining the batter between the two plates 102A/102B. In such an embodiment, the sliding crescent gate distance 144 may increase as the batter volume expands (for example, as heat is applied to the batter). Thus, the rising batter may apply pressure to the top plate 102A, increasing the distance between the top plate 102A and the bottom plate 102B, specifically the inner top plate rim 110A and the inner bottom plate rim 110B (for example, the sliding crescent gate 142). In an embodiment, the top plate 102A “floats” in the batter as it rises.

In an embodiment, as the batter expands, the top plate 102A and the bottom plate 102B separate. Further, as the batter expands, the waffle parting line 140 may also rise. In an embodiment, the waffle maker exists in a passive state prior to application of heat and an active state after the application of heat. In an embodiment, the waffle parting line 140 remains equidistant from the top plate 102A and the bottom plate 102B in all states.

In an embodiment, as the batter expands, surplus batter may surge towards the top plate rim 108A and bottom plate rim 108B. Specifically, in an embodiment, the batter may enter the reservoir 130 and then the sliding crescent gate 142. The upward curve of the sliding crescent gate 142 may prevent surplus batter from exiting the plates 102A/102B (for example, through the seal 148). Instead of flowing out of the seal 148, the batter may become trapped in the sliding crescent gate 142. Additionally, the distance between the waffle parting line 140 and the sliding crescent gate 142 may prevent surplus batter from exiting the cavity 124 by increasing the distance that surplus batter must travel to traverse the seal 148. In such an embodiment, the deep positioning of the top plate 102A and the bottom plate 102B in relation to the sliding crescent gate 142 aids in preventing batter overflow. In an embodiment, the sliding crescent gate 142 may also be configured to act as a moat as the top plate 102A and the bottom plate 102B separate.

In an alternate embodiment, the shape of the sliding crescent gate 142 may not be curved and may prevent batter overflow. As a non-limiting example, the sliding crescent gate 142 may be a square-shaped step. In such a non-limiting example, the top inner rim 108A and the bottom inner rim 108B may include one or more complimentary steps. In another embodiment, the top inner rim 108A and the bottom inner rim 108B may only partially make contact. In such an embodiment, the top inner rim 108A and the bottom inner rim 108B are not completely complimentary. For example, the top inner rim 108A may be curved at a greater angle than the bottom inner rim 108B.

In an embodiment, when in a passive mode (for example, no batter present), the outer rim distance 146, the reservoir distance 152, the circumferential trench distance 136, the teeth distance 132, and the groove distance 134, may be non-zero. In another embodiment, when in a passive mode, the seal distance 146 may be zero. In an embodiment, when in a passive mode, the inner rim distance 144 may be zero. However, in an alternate embodiment, the inner rim distance 144 may be non-zero in a passive mode. In an embodiment, when in an active mode, the outer rim distance 146, the inner rim distance 144, the reservoir distance 152, the circumferential trench distance 136, the teeth distance 132, and the groove distance 134 may be non-zero.

In an embodiment, the reservoir inlet 156 may be open in both a passive mode and an active mode. In another embodiment, the reservoir inlet 156 may be closed in a passive mode. In such an embodiment, the reservoir inlet 156 may be curved such that the force of surging batter may open the reservoir inlet 156.

In an embodiment, the sliding crescent gate inlet 150 may be open in both a passive mode and an active mode. In another embodiment, the sliding crescent gate inlet 150 may be closed in a passive mode. The sliding crescent gate inlet 150 may be curved such that the force of surging batter may open the sliding crescent gate 142. The sliding crescent gate inlet 150 may be above the waffle parting line 140. In an embodiment, the sliding crescent inlet 150 may begin to open as batter enters the reservoir 130. However, in another embodiment, the sliding crescent inlet 150 may begin to open once the reservoir 130 is full of batter.

In an embodiment, the top plate rim 108A and/or the bottom plate rim 108B are in contact with the heating element 126, such that batter trapped between the sliding crescent gate 142 and/or the seal 148 may cook. In such an embodiment, the top plate rim 108A and/or the bottom plate rim 108B may be in indirect contact with the heating element 126 or may otherwise receive a quantity of heat less than that transferred to the top plate 102A or bottom plate 102B proper. For example, as the volume and depth of batter between the top plate rim 108A and the bottom plate rim 108B may be less than the volume and depth of the batter between the plates 102A/102B proper, the batter may cook quickly along the rims 108A/108B. Thus, a lower temperature rim may prevent batter from burning at the rims 108A/108B. Such a lower temperature may be configured as a function of the distance of the rim 108A/108B to the heating element 126. In another embodiment, such a lower temperature is programmed into the heating element 126. For the purposes of this disclosure, “plate proper” may refer to the teeth, grooves, partitions, and circumferential trenches of the plates.

In an embodiment, the invention of the present disclosure may be a waffle maker, comprising a top plate bound by a top body, where the top plate comprises a plurality of top plate teeth, a plurality of top plate grooves, a top plate rim, a top plate circumferential trench, a top plate reservoir trench, and a top plate partition, and where the top plate rim comprises a top plate inner rim and a top plate outer rim. The waffle maker may also include a bottom plate bound by a bottom body, the bottom plate comprising a plurality of bottom plate teeth, a plurality of bottom plate grooves, a bottom plate rim, a bottom plate circumferential trench, a bottom plate reservoir trench, and a bottom plate partition, and where the bottom plate rim comprises a bottom plate inner rim and a bottom plate outer rim. Further, in an embodiment, the waffle maker comprises a cavity bound by the top plate and the bottom plate, the cavity configured to accept a batter, a reservoir bound by the top plate reservoir trench and the bottom plate reservoir trench, where the top plate reservoir trench is a concave down curve and the bottom plate reservoir trench is a concave up curve, and a circumferential trench bound by the top plate circumferential trench and the bottom plate circumferential trench. In an embodiment, the waffle maker may also comprise a sliding crescent gate bound by the top plate inner rim and the bottom plate inner rim, where the reservoir is disposed between the sliding crescent gate and the circumferential trench, and wherein the top plate inner rim and the bottom plate inner rim are concave up curves. In yet a further embodiment, the waffle maker comprises a seal bound by the top plate outer rim and the bottom plate outer rim, where the top plate inner rim extends from the top plate reservoir trench to the top plate outer rim, where the bottom plate inner rim extends from the bottom plate reservoir trench to the bottom plate outer rim, wherein the top plate floats atop the batter, and where the top plate inner rim is configured to rise as the batter expands.

In an embodiment, the sliding crescent gate is above a waffle parting line, the waffle parting line may be disposed between the top plate and the bottom plate, horizontally traversing the cavity, and equidistant from the top plate and the bottom plate. The top plate outer rim and the bottom plate outer rim are parallel. In an embodiment, the sliding crescent gate is configured to form a sliding crescent moat as the top plate rises and the batter expands.

In an embodiment, the top plate inner rim and bottom plate inner rim have complimentary curvature. In an embodiment, the top plate reservoir trench has a cross-sectional top plate reservoir trench length and the bottom plate reservoir trench has a cross-sectional bottom plate reservoir trench length, where the cross-sectional top plate reservoir trench length is less than the cross-sectional top plate reservoir trench length.

In an embodiment, the device further comprises a reservoir inlet and a sliding crescent gate inlet, where the sliding crescent gate inlet is disposed at a greater height than the reservoir inlet. The device may comprise an active mode and a passive mode and an inner rim distance and an outer rim distance. The inner rim distance and the outer rim distance may be zero in the passive mode. Alternatively, the inner rim distance may be zero in the passive mode and the outer rim distance may be non-zero in the passive mode. The sliding crescent gate inlet and the reservoir inlet may be closed in the passive mode. Alternatively, the sliding crescent gate inlet may be closed in the passive mode and the reservoir inlet may be open in the passive mode. In an embodiment, the reservoir is uniform. The top plate outer rim and the bottom plate outer rim may be horizontal and flat.

While certain novel features of the present invention have been shown and described, it will be understood that various omissions, substitutions and changes in the forms and details of the device illustrated and in its operation can be made by those skilled in the art without departing from the spirit and scope of the invention.

What is claimed is:

1. A waffle maker, comprising:
a top plate bound by a top body, the top plate comprising:
a plurality of top plate teeth, a plurality of top plate grooves, a top plate rim, a top plate circumferential trench, a top plate reservoir trench, and a top plate partition,
wherein the top plate rim comprises a top plate inner rim and a top plate outer rim;
a bottom plate bound by a bottom body, the bottom plate comprising:
a plurality of bottom plate teeth, a plurality of bottom plate grooves, a bottom plate rim, a bottom plate circumferential trench, a bottom plate reservoir trench, and a bottom plate partition,
wherein the bottom plate rim comprises a bottom plate inner rim and a bottom plate outer rim;
a cavity bound by the top plate and the bottom plate, the cavity configured to accept a batter;
a reservoir bound by the top plate reservoir trench and the bottom plate reservoir trench,
wherein the top plate reservoir trench is a concave down curve and the bottom plate reservoir trench is a concave up curve;
a circumferential trench bound by the top plate circumferential trench and the bottom plate circumferential trench;
a sliding crescent gate bound by the top plate inner rim and the bottom plate inner rim,
wherein the reservoir is disposed between the sliding crescent gate and the circumferential trench; and
wherein the top plate inner rim and the bottom plate inner rim are concave up curves;
a seal bound by the top plate outer rim and the bottom plate outer rim,
wherein the top plate inner rim extends from the top plate reservoir trench to the top plate outer rim;
wherein the bottom plate inner rim extends from the bottom plate reservoir trench to the bottom plate outer rim;
wherein the top plate floats atop the batter; and
wherein the top plate inner rim is configured to rise as the batter expands.

2. The waffle maker of claim 1, wherein the sliding crescent gate is above a waffle parting line, the waffle parting line disposed between the top plate and the bottom plate, horizontally traversing the cavity, and equidistant from the top plate and the bottom plate.

3. The waffle maker of claim 1, wherein the top plate outer rim and the bottom plate outer rim are parallel.

4. The waffle maker of claim 1, wherein the sliding crescent gate is configured to form a sliding crescent moat as the top plate rises and the batter expands.

5. The waffle maker of claim 1, wherein the top plate inner rim and bottom plate inner rim have complimentary curvature.

6. The waffle maker of claim 1, wherein the top plate reservoir trench has a cross-sectional top plate reservoir trench length and the bottom plate reservoir trench has a cross-sectional bottom plate reservoir trench length, and wherein the cross-sectional top plate reservoir trench length is less than the cross-sectional top plate reservoir trench length.

7. The waffle maker of claim 1, further comprising a reservoir inlet and a sliding crescent gate inlet, wherein the sliding crescent gate inlet is disposed at a greater height than the reservoir inlet.

8. The waffle maker of claim 7, further comprising an active mode and a passive mode.

9. The waffle maker of claim 8, further comprising an inner rim distance and an outer rim distance.

10. The waffle maker of claim 9, wherein the inner rim distance and the outer rim distance are zero in the passive mode.

11. The waffle maker of claim 9, wherein the inner rim distance is zero in the passive mode and the outer rim distance is non-zero in the passive mode.

12. The waffle maker of claim 8, wherein the sliding crescent gate inlet and the reservoir inlet are closed in the passive mode.

13. The waffle maker of claim 8, wherein the sliding crescent gate inlet is closed in the passive mode and the reservoir inlet is open in the passive mode.

14. The waffle maker of claim 1, wherein the reservoir is uniform.

15. The waffle maker of claim 3, where in the top plate outer rim and the bottom plate outer rim are horizontal and flat.
